(19) United States
(12) Patent Application Publication
(10) Pub. No.: US 2023/0252465 A1
(43) Pub. Date: Aug. 10, 2023

(54) METHOD AND SYSTEM FOR THE EXECUTION OF A TRANSACTION ON A DISTRIBUTED LEDGER

(71) Applicant: VIOLETTE SASU, PARIS (FR)

(72) Inventor: Antoine HERZOG, PARIS (FR)

(21) Appl. No.: 17/810,191

(22) Filed: Jun. 30, 2022

(30) Foreign Application Priority Data
Feb. 10, 2022 (FR) 2201167
Mar. 16, 2022 (FR) 2202315

(51) Int. Cl. G06Q 20/38

(52) U.S. Cl. CPC G06Q 20/389; G06Q 20/3829

(57) ABSTRACT

The method (700) for the execution of a transaction on a distributed ledger comprises:
a step (705) of defining a transaction with an unknown second public address, said transaction requiring said second public address to be registered on the distributed ledger;
a step (110) of creating, by the first computing device, a cryptographic secret;
a step (115) of registering a transitory entry in a distributed ledger representative of a preparatory state of the defined transaction;
a step (120) of generating at least one resource address on a computer network representative of the defined transaction;
a step (125) of transmitting at least one resource address on a computer network through a data network and said cryptographic secret;
a step (130) of receiving at least one transmitted resource address and said cryptographic secret;
a step (131) of accessing a resource corresponding to the received resource address;
a step (710) of inputting the cryptographic secret as a parameter of execution of the defined transaction and
a step (135) of registration of the defined transaction in the distributed ledger, by the second computing device, as a function of the input cryptographic secret.

### TECHNICAL FIELD OF THE INVENTION

The present invention aims at a method for the execution of a transaction on a distributed ledger and at a system for the execution of a transaction on a distributed ledger. This invention applies, in particular, to the field of cryptography and blockchain technologies.

### BACKGROUND OF THE INVENTION

The execution of transactions on a distributed ledger, between two parties, typically requires the knowledge by an initiating party of the public address of the other party.

In a first example, the modification of a smart contract might require the signature of the other party to complete a clause specified within the smart contract. Current systems are thus limited in their use due to this public address knowledge requirement on behalf of the initiating party.

In a second example, the transfer of cryptographic assets typically requires the knowledge, by the sender, of the public address of the recipient.

Cryptographic assets refer to transferable digital representations that are designed in a way that prohibits their copying or duplication. Such cryptographic assets may be decentralized digital currencies or non-fungible tokens.

Such cryptographic assets are associated with a private key in a public-key or asymmetric cryptography system, representative of ownership of said cryptographic assets.

Such private keys are typically stored in a type of software called “wallets”.

In the field of cryptographic assets, the transfer of cryptographic assets from wallet to wallet is a core feature of distributed ledgers such as blockchains. In such systems, a cryptographic transaction is recorded in the distributed ledger, said transaction being associated to the cryptographic assets transferred between an issuing wallet and a receiving wallet according to the private keys of these wallets.

Such systems present several difficulties.

On the one hand, such systems cannot function if the recipient does not initially possess a public address on a distributed ledger compatible with the cryptographic assets. Furthermore, the sender needs to know this address. Furthermore, there is a risk attached to entering the destination public address, which is typically a long character string, which can lead to an erroneous transaction and the loss of the associated cryptographic assets.

On the other hand, in so-called custodial depository systems, such as the Coinbase (registered trademark) platform for example, all wallets are administered by a single entity that may fail, thus resulting in the loss of the associated cryptographic assets. Furthermore, the cryptographic asset storing devices (“wallets”) of the sender and the recipient must be identical.

Thus, there is no decentralized, reliable, and simple way to transfer crypto assets to any recipient. This is one of the main limitations currently preventing the democratization of blockchain technology.

### SUMMARY OF THE INVENTION

The present invention aims at solving all or part of these drawbacks.

To this effect, the present invention aims at a method for the execution of a transaction on a distributed ledger, comprising:
a step of defining a transaction, upon a computer interface associated to a first computing device associated with a first public address, with an unknown second public address, said transaction requiring said second public address to be registered on the distributed ledger;
a step of creating, by the first computing device, a cryptographic secret;
a step of registering a transitory entry in a distributed ledger, by the first computing device, representative of a preparatory state of the defined transaction, the completion of said transaction being performed as a function of the cryptographic secret;
a step of generating, by the first computing device, at least one resource address on a computer network representative of the defined transaction;
a step of transmitting, by the first computing device, at least one resource address on a computer network through a data network and said cryptographic secret;
a step of receiving, by a second computing device, at least one transmitted resource address and said cryptographic secret;
a step of accessing, by the second computing device, a resource corresponding to the received resource address;
a step of inputting, by the second computing device, the cryptographic secret as a parameter of execution of the defined transaction and
a step of registration of the defined transaction in the distributed ledger, by the second computing device, as a function of the input cryptographic secret.

Such provisions allow for the execution of a transaction on the distributed ledger with an unknown recipient. For example, such provisions allow for the modification of a smart contract or the transfer of cryptographic assets.

For example, this invention can be used to transfer bitcoin from a first user to a second user, possibly either unknown or who’s public address is unknown to the first user, which is impossible in current systems. These advantages are obtained regardless whether or not the wallets of the users are managed by a custodial system.

In particular embodiments, the method object of the present invention is configured for the execution of a cryptographic asset transfer transaction on a distributed ledger, in which:
the step of defining a transaction comprises a step of selecting, upon a computer interface associated to a first computing device of a cryptographic asset associated with a first private address to be transferred to an unknown second private address;
the step of creating a cryptographic secret is configured to generate a transitory private key;
the step of registering an entry in a distributed ledger is configured to register, by a first computing device, representative of the transfer of a cryptographic asset from a first public address, represented by a first private key, to a transitory public address, associated to the transitory private key;
the step of generating is configured to generate at least one resource address on a computer network comprising information representative of the transitory private key;
the step of transmitting, by the first computing device, at least one resource address on a computer network through a data network;
the step of registration is configured to register a transaction in the distributed ledger, by the second computing device, representative of the transfer of the cryptographic asset from the transitory public address, represented by the transitory private key, to a second address, represented by a second private key associated to the second computing device.

Thanks to these provisions, the transfer of cryptographic assets is performed through accessing the resource address (i.e., links or URLs), possibly on a network or directly on the second computing device, with no need for the sender to know the address of the recipient on the distributed ledger compatible with the transferred assets, nor that the recipient already has such an address or access to a private key storing device (a “wallet”). Furthermore, this process does not require any technical skills from the recipient. Furthermore, the transfer is done with no direct manipulation of private keys by users. The process is thus simple to use, reliable because it uses a distributed ledger and decentralized because it does not rely on a central authority having possession of the cryptographic assets.

In particular embodiments, the method object of the invention comprises, downstream of the step of receiving, a step of creating, by the second computing device, the second private key, said second private key being used during the step of adding a finalized entry.

Such embodiments allow for the distribution of cryptographic assets to users not yet associated with the corresponding distributed ledger.

In particular embodiments, the method object of the invention comprises, downstream of the step of receiving:
a step of identifying, by the second computing device of at least one private key storage software (e.g., a wallet software) and
a step of selecting, upon a computer interface associated with the second computing device, an identified private key storage software, the second private key being associated with the selected private key storage software.

Such embodiments allow for the synchronization of a wallet already available upon the second computing device to be used by the receiving user.

In particular embodiments, the method object of the invention comprises a step of association of at least one identifier representative of a type of transaction and at least one private key storage software, the step of identifying being performed as a function of a type of transaction associated with the resource address.

Such embodiments allow for the choice of a wallet to be used by the receiving user if several wallets are available and compatible with a particular distributed ledger technology.

In particular embodiments, the method object of the invention comprises a step of redirecting to a secondary resource on a computer network as a function of the result of the step of identifying, said secondary resource being configured to download a private key storage software upon the second computing device.

Such embodiments allow for the distribution of cryptographic assets to users not yet associated with the distributed ledger, as said users may download a private key storage software before receiving said assets.

In particular embodiments, the method object of the invention comprises a step of encoding, by the first computing device, the transitory key to form at least one resource address on a computer network.

Such embodiments allow for the completion of the defined transaction without requiring the direct manipulation of the cryptographic secret by the recipient.

In particular embodiments, the method object of the invention comprises:
a step of extracting, by the first computing device, a segment of the transitory private key;
a step of sending, by the first computing device, said fragment to the second computing device;
a step of inputting, upon a computer interface associated with the second computing device, the fragment to form a set of at least one complete transitory private key, the step of registration being performed as a function of the complete transitory private key.

Such embodiments allow for the secure transfer of the transitory private key across a computer network by removing a part of the transferred transitory private key before including it in a resource address that can in some cases be sent on a data network.

In particular embodiments, at least two complementary resource addresses are generated, each said network address being configured to be opened sequentially by the second computing device.

Such embodiments allow for the secure transfer of the transitory private key across a computer network or any other communication channel.

According to a second aspect, the present invention aims at a system for the execution of a transaction on a distributed ledger, comprising:
a first computing device associated with a first public address, comprising a computer interface, configured to execute instructions corresponding to the following steps:
a step of defining a transaction with an unknown second public address, said transaction requiring said second public address to be registered on the distributed ledger;
a step of creating a cryptographic secret.
a step of registering a transitory entry in a distributed ledger representative of a preparatory state of the defined transaction, the completion of said transaction being performed as a function of the cryptographic secret;
a step of generating at least one resource address on a computer network representative of the defined transaction;
a step of transmitting at least one resource address on a computer network through a data network and said cryptographic secret;
a second computing device associated with a first public address configured to execute instructions corresponding to the following steps:
a step of receiving at least one transmitted resource address and said cryptographic secret;
a step of accessing a resource corresponding to the received resource address;
a step of inputting the cryptographic secret as a parameter of execution of the defined transaction and
a step of registration of the defined transaction in the distributed ledger as a function of the input cryptographic secret.

The advantages of the system object of the present invention are similar to the advantages of the method object of the present invention.

### BRIEF DESCRIPTION OF THE DRAWINGS

Further advantages, purposes and special features of the invention will be apparent from the following non-limiting description of at least one particular embodiment of the method and system object of the present invention, with reference to the appended drawing in which:

FIG. 1 represents, in the form of a flowchart, a first particular succession of steps of a method object of the present invention,

FIG. 2 represents, in the form of a flowchart, a second particular succession of steps of a method object of the present invention,

FIG. 3 represents, schematically, a first particular embodiment of the system object of the present invention,

FIG. 4 represents, schematically, a first set of interfaces of a second particular embodiment of the system object of the present invention,

FIG. 5 represents, schematically, a second set of interfaces of a second a particular embodiment of the system object of the present invention,

FIG. 6 represents, schematically, a third set of interfaces of a second a particular embodiment of the system object of the present invention and

FIG. 7 represents, in the form of a flowchart, a third particular succession of steps of a method object of the present invention.

### DETAILED DESCRIPTION OF THE INVENTION

It should be noted that all figures are not to scale.

In the context of the present description, as an example, two separate users, each associated with a distinct device, are engaging in a transfer of bitcoin. These two users do not know if the other has a wallet to store said bitcoin but need to initiate the transaction regardless. In order to achieve this, the sending user transfers the bitcoin to a temporary address associated with neither user and possibly generated exclusively for this transaction. The private key associated with the temporary address is then used to generate a link to an address on a computer network that, when accessed by the receiving user, allows the transfer of bitcoin from the temporary address to the final address associated with the second user; said final address being known by the second user.

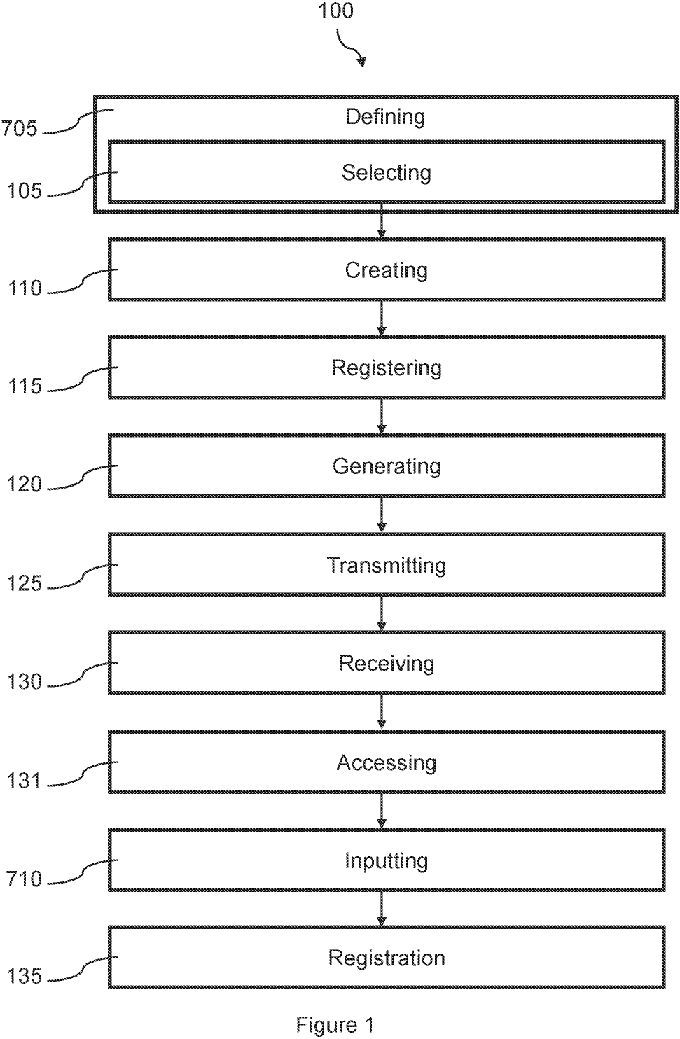

FIG. 1 represents a particular embodiment in which the objective of the method 100 is to send bitcoin or any other cryptographic asset between users without the sender knowing the public address of the recipient on the blockchain.

FIG. 1 represents, in the form of a flowchart, a particular succession of steps of the method 100 object of the present invention. This method 100 configured for the execution of a cryptographic asset transfer transaction on a distributed ledger, comprises:
the step 705 of defining a transaction comprises a step 105 of selecting, upon a computer interface associated to a first computing device of a cryptographic asset associated with a first private address to be transferred to an unknown second private address;
the step 110 of creating a cryptographic secret is configured to generate a transitory private key;
the method further comprises a step 115 of registering an entry in a distributed ledger, by a first computing device, representative of the transfer of a cryptographic asset from a first public address, represented by a first private key, to a transitory public address, associated to the transitory private key; - the step 120 of generating is configured to generate at least one resource address on a computer network comprising information representative of the transitory private key;
the step 125 of transmitting, by the first computing device, at least one resource address on a computer network through a data network;
the step 135 of registration is configured to register a transaction in the distributed ledger, by the second computing device, representative of the transfer of the cryptographic asset from the transitory public address, represented by the transitory private key, to a second address, represented by a second private key associated to the second computing device.

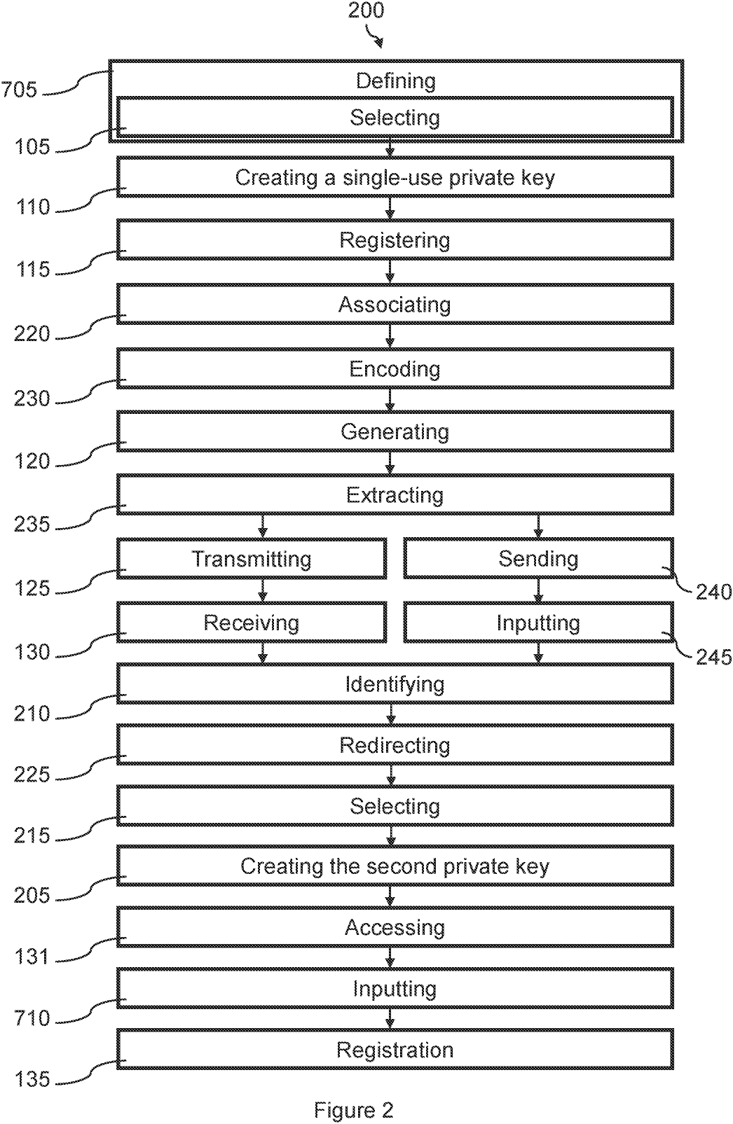

The method 100 shown in FIG. 1 may be considered as minimal, in that it is limited to a small number of steps and shows a limited number of variants in this succession of steps. The method 200, shown in FIG. 2, illustrates numerous variants that can be applied to the method 100 shown in FIG. 1.

The step 105 of selecting may be performed, for example, by any means of inputting relevant to the particular use case. For example, during this step 105 of selecting, a user may access the GUI of a computer program run upon the first computing device, such as a smartphone. Upon this GUI, the user may select at least one cryptographic asset among a list of available cryptographic assets, including for example cryptocurrencies or non-fungible tokens. Such a selection may be performed by clicking, with a mouse cursor, or touching a touchscreen to interact with the GUI. During this step 105 of selecting, a quantity of the selected cryptographic asset may also be set. Such a quantity may refer, for example, to a number of units of a particular cryptocurrency.

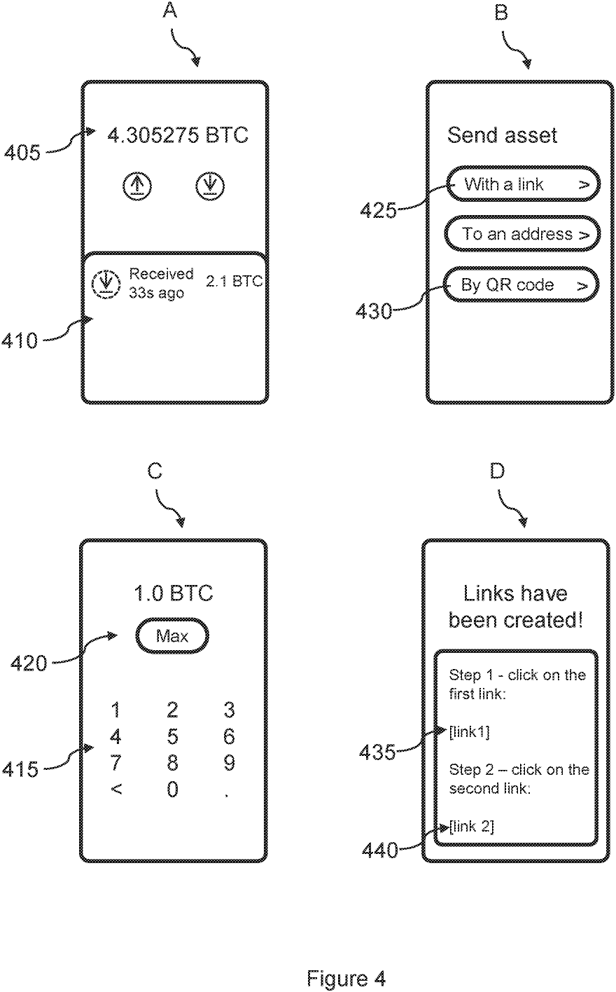

Such a step 105 of selecting is illustrated in FIGS. 4A and 4C.

In FIG. 4A, a list of one cryptographic asset 405, Bitcoin (or “BTC”), is available for transfer.

In more advanced embodiments, several cryptographic assets are available, and the GUI uses a selector to allow for the selection, by the user, of the cryptographic asset to be transferred.

In more advanced embodiments, the user may select several distinct cryptographic assets and/or several quantities of distinct cryptographic assets to be transferred. In such embodiments, the GUI may comprise a shopping cart type of display showing the user which cryptographic assets are selected and which associated quantities are set. FIG. 4A further shows a log 410 of all transactions completed relative to the selected cryptographic asset. In this case, 2.1 units of BTC have been received or deposited into the wallet of the user handling the GUI.

In FIG. 4C, the GUI provides a number pad 415 for a user to select a quantity of a cryptographic asset to transfer as well as a button 420 allowing for the setting of said quantity to the maximum allowable value. In this case, 1 unit of BTC is to be transferred to a second user.

The step 110 of creating is performed, for example, by a computer program run upon the first computing device or a computing device associated with the first computing device, such as a distant server, upon receiving a command emitted by the first computing device.

In this variant, the step 110 of creating is configured to create a transitory private key. Such a step 110 of creating a transitory private key typically involves the creation of an exceptionally large integer value, represented for a user by a series of alphabetic characters organized into distinct words. This integer value, typically randomly generated, acts as a private key in a distributed ledger system. The size of said integer depends on the public-private key protocol used in the distributed ledger technology. For example, on the bitcoin blockchain, the private key is a 256-bit long string.

The created private key is made to be of transitory during the execution of the method 100 object of the present invention. This means that this transitory private key is preferentially used only for a single transaction then discarded from the system. In particular embodiments, the transitory private key is never shown to the user of the first computing device or to the user of the second computing device. The purpose of the transitory private key is to create a temporary address to store the cryptographic asset prior to the retrieval of said cryptographic asset by the second computing device. This allows the transfer of cryptographic assets to users not already associated with the distributed ledger technology (not in possession of a private key) or to users whose address associated with the private key is unknown to the sender.

The step 115 of registering an entry is performed for example, by a computer program run upon the first computing device or a computing device associated with the first computing device, such as a distant server, upon receiving a command emitted by the first computing device. Such a step 115 of registering may be performed several times in the event where several cryptographic assets are selected for transfer.

The implementation of this step 115 of registering an entry depends on the nature of the distributed ledger technology used. Typically, the confirmation of the addition of the entry relies upon a consensus mechanism, which can be, for example, a proof of work or proof of stake consensus mechanism. Such a step 115 of registering is well known in the field of distributed ledgers.

Such a step 115 of registering may be performed a plurality of times in the event where several distinct types of cryptographic assets are selected.

The distributed ledger technology corresponds to the technology used for the selected cryptographic asset.

Regardless of the underlying distributed ledger technology used, the entry is representative of a transaction in which the public address associated with the first private key is listed as the sender, the public address associated with the transitory private key is listed as the receiver and, optionally, the quantity of the transaction corresponds to the set quantity of the selected cryptographic asset.

The step 120 of generating a resource address on a network is performed for example, by a computer program run upon the first computing device or a computing device associated with the first computing device, such as a distant server, upon receiving a command emitted by the first computing device.

In a simple embodiment, the resource address is a URL comprising the transitory private key as a file suffix, such as for example, the concatenation of “https://sol.cryptoplease.link?key=” and the transitory private key in alphanumerical format. The subdomain and domain elements of the URL refer, for example, to an address associated with the computer program in charge of the step 710 of inputting. In more complex embodiments, two or more resource addresses are generated, each address comprising a segment of the transitory private key. For example, two URLs may be generated as such:
the concatenation of “https://sol.cryptoplease.link?key=” and a first half transitory private key in alphanumerical format and
the concatenation of “https://sol2.cryptoplease.link?key=” and a second half transitory private key in alphanumerical format.

A particular example of such embodiments is shown in FIGS. 4B and 4D, in which a GUI allows for a user to generate a URL upon the click of a button 425, said URL being sent through any communication channel between the first and the second computing devices. FIG. 4B further shows, upon the GUI, a button 430 allowing for the creation of a QR Code representative of the generated URL. Such a variant allows for the scan of the QR code by an optical system associated with the second computing device.

In such embodiments, the device of the recipient looks for software already installed locally that can handle requests that begin with sol.cryptoplease.link. If there is more than one, one must be chosen. Then this program is run and provided with the link to process. This program then extracts the private key or part of the private key from the link. If the device of the recipient does not find software already installed that is capable of handling requests that begin with sol.cryptoplease.link, then the request is sent to the server that hosts the cryptoplease.link domain, which redirects this request to a download server that allows the recipient to install software capable of handling requests that begin with sol.cryptoplease.link.

FIG. 4D shows embodiments in which two separate URLs, 435 and 440, (or QR codes) are generated and ready to be transferred to the second computing device, regardless of the mechanism used for said transfer.

The step 125 of transmitting is performed for example, by a computer program run upon the first computing device or a computing device associated with the first computing device, such as a distant server, upon receiving a command emitted by the first computing device.

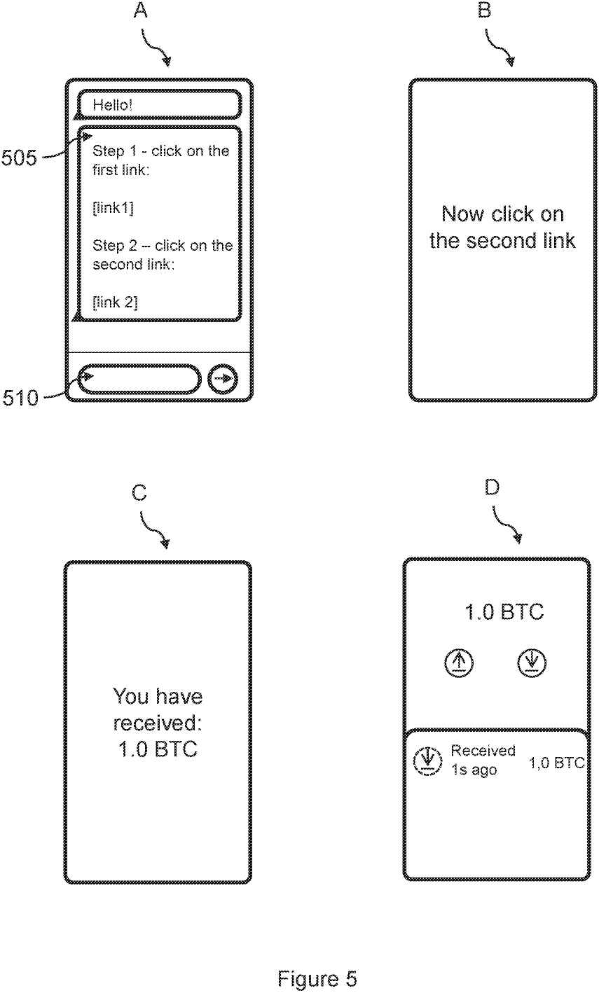

During this step 125 of transmitting, the resource address generated may be sent by any transfer mechanism typically used in digital communication. In an example shown in FIG. 5A, an instant messaging application is used, the resource address generated being transmitted as a message 505 that has been input using an input field 510. The message 505 can then be viewed and interacted with by the user of the second computing device. During this step 125 of transmitting, the cryptographic secret is also transmitted.

In particular embodiments, the cryptographic secret is transmitted in a dedicated step (not represented) of transmitting.

In particular embodiments, the cryptographic secret is embedded into the resource address.

The step 130 of receiving is performed for example, by a computer program run upon the second computing device or a computing device associated with the second computing device, such as a distant server, upon receiving a command emitted by the second computing device.

The nature of the step 130 of receiving depends on the nature of the step 125 of transmitting. In an example shown in FIG. 5A, an instant messaging application is used, the resource address generated being transmitted as a message 505 that has been input using an input field 510. The message 505 can then be viewed and interacted with by the user of the second computing device.

In the example shown in FIG. 5A, the transitory private key is split into two separate resource addresses. Upon clicking on the first URL, the user of the second computing device is directed to the interface shown in FIG. 5B, inviting said user to click on the second URL. Upon clicking on the second URL, the transitory private key is complete, and the transaction is completed.

In such embodiments, at least two complementary resource addresses are generated, each said network address being configured to be opened sequentially by the second computing device.

The step 131 of accessing is performed for example, by a computer program run upon the second computing device or a computing device associated with the second computing device, such as a distant server, upon receiving a command emitted by the second computing device.

During this step of accessing 131, the resource address is used to reach the ressource, said ressource being either distant or local. Preferably, accessing this resource triggers the step of inputting 710 with the objective of, once the cryptographic has been input, triggering the step 135 of registration.

The step 710 of inputting, in such an embodiment, may correspond to the extraction of the transitory private key from the network resource address and to the input of said transitory private key as a parameter of the step 135 of registration.

The step 135 of registration of an entry is performed for example, by a computer program run upon the second computing device or a computing device associated with the second computing device, such as a distant server, upon receiving a command emitted by the second computing device. This step 135 of registration is similar to the step 115 of registering.

In particular variants, in at least one of the two links the private key portion is replaced by an identifying string allowing to retrieve the private key portion stored on a server (“tinyurl” method for exchanging shorter links).

In other variants, one of the two links is replaced by a pin code allowing a user to complete the private key or to retrieve from a server a portion of the private key (with a limited number of attempts for example).

The added entry is representative of a transaction in which the public address associated with the transitory private key is listed as the sender, the public address associated with the second private key is listed as the recipient and the cryptographic assets transferred are all the cryptographic assets initially selected.

Upon completion, the second user may view the received cryptographic asset upon a GUI associated with the second computing device, such as shown in FIG. 5D.

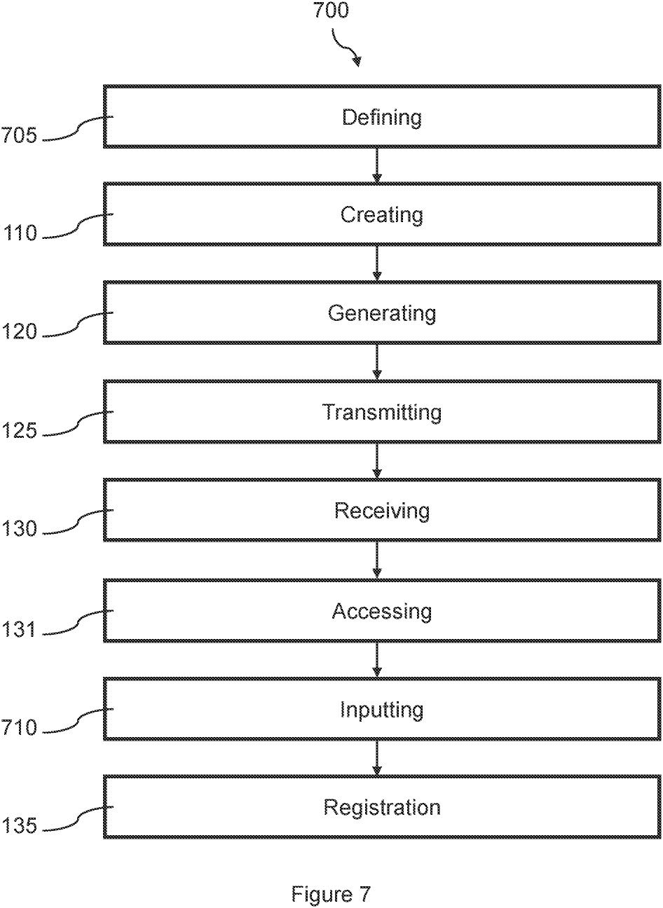

FIG. 7 represents, in the form of a flowchart, a particular succession of steps of the method 700 object of the present invention. This method 700 may be used for the execution of a transaction on a distributed ledger.

Typically, a transaction on a distributed ledger requires for a first user or device initiating the transaction to know the public address of the second user or device, much in the same way that, in a contract, contracting parties are stated and required for the validity of the contract. A transaction thus represents a cryptographic event between two public addresses associated to a distributed ledger.

In the method 700 object of the present invention, during a step 705 of defining, a type of transaction may be selected (such as a transfer of bitcoin, NFTs or the execution of a smart contract for example). Contrarily to prior systems, this step 705 of defining is unilateral on the part of the sender, emitter or initiator of the transaction.

For the transaction to be validated by the recipient, receiver or target of the transaction, considering the fact that the second public address is initially unknown, the method 700 uses cryptographic secrets, that is created during a step 110 of creating, that a second user or device associated to the intended second public address must enter or interact with in order to validate that this second user or device is indeed the target of the transaction. Such a cryptographic secret may be a URL or password, for example. In the method 700 object of the present invention, once a transaction has been defined, a transitory entry or transaction is stored on the distributed ledger by the initiating user or device. Several possibilities may be employed during this step 115 of registering a transitory entry, as shown below. A transitory entry may correspond to, for example, the transfer of bitcoin to a transitory public address.

Once the transitory entry is stored, a link may be generated, said link being representative of a network address associated with the cryptographic secret and the transitory entry.

This allows, during a step 125 of transmitting, to send the link and cryptographic secret via a computer network, such as a digital message via the internet for example.

In turn, this allows, during a step 131 of accessing the network address associated to the generated link and, depending on the nature of the cryptographic secret, to prepare the validation of the definitive transaction. Several embodiments are disclosed below. The cryptographic secret is then associated with the network address (such as entering a password in a webpage associated with the generated link or having part of the generated link extracted and used as the cryptographic secret) in order to launch the execution of the defined transaction.

If the cryptographic secret inputted on the second computer matches the defined transaction is registered and otherwise it is rejected.

The step 705 of defining a transaction is performed, for example, by a computer program run upon the first computing device or a computing device associated with the first computing device, such as a distant server. The nature of this step 705 of defining depends on the particular implementation use case of the method 700 object of the present invention. An example of such a step 705 of defining is provided in regard of FIGS. 1 and 2.

In a particular example of a transaction involving a smart contract, for example, an organization manages the list of the members of the association on a blockchain, in what is called a “DAO” (for Decentralized Autonomous Organization).

In this example, a smart contract exists and lists all current members of the association, defined by the public keys of said members.

In this example, a DAO administrator wishes to add a member to the organization. During the step 705 of defining, the administrator sends a first transaction upon the DAO or that administrator’s smart contract to allow adding a member to the DAO, provided this new member is able to sign a message with a transitory private key that is generated by the administrator.

The step 110 of creating is performed, for example, by a computer program run upon the first computing device or a computing device associated with the first computing device, such as a distant server, upon receiving a command emitted by the first computing device.

The nature of this step 110 of creating depends on the particular implementation use case of the method 700 object of the present invention. An example of such a step 110 of creating is provided in regard of FIGS. 1 and 2.

In the example of the DAO described above, the secret may be a transitory private key.

The step 115 of registering is performed for example, by a computer program run upon the first computing device or a computing device associated with the first computing device, such as a distant server, upon receiving a command emitted by the first computing device. An example of such a step 110 of creating is provided in regard of FIGS. 1 and 2. An example of such a step 115 of registering is provided in regard of FIGS. 1 and 2.

During this step 115 of registering, the defined transaction is incomplete and requires another, complementary registration, to be finalized. This complementary transaction may only be performed by a user knowing the cryptographic secret.

In the example of the DAO described above, the step 115 of registering may correspond to the initial transaction performed by the DAO administrator allowing for the addition of a member to the DAO provided a particular private key (secret) is provided.

The step 120 of generating a resource address on a network is performed for example, by a computer program run upon the first computing device or a computing device associated with the first computing device, such as a distant server, upon receiving a command emitted by the first computing device. Such a resource address may also correspond to a dynamic link.

The nature of this step 120 of generating depends on the particular implementation use case of the method 700 object of the present invention. An example of such a step 120 of generating is provided in regard of FIGS. 1 and 2.

The step 125 of transmitting is performed for example, by a computer program run upon the first computing device or a computing device associated with the first computing device, such as a distant server, upon receiving a command emitted by the first computing device. The cryptographic secret is also sent during this step 125 of transmitting or during a dedicated step (not represented) of transmitting of the cryptographic secret.

During this step 125 of transmitting, the resource address generated may be sent by any transfer mechanism typically used in digital communication. In an example shown in FIG. 5A, an instant messaging application is used, the resource address generated being transmitted as a message 505 that has been input using an input field 510. The message 505 can then be viewed and interacted with by the user of the second computing device.

The step 130 of receiving is performed for example, by a computer program run upon the second computing device or a computing device associated with the second computing device, such as a distant server, upon receiving a command emitted by the second computing device. The cryptographic secret is also received during this step 130 of receiving or during a dedicated step (not represented) of receiving of the cryptographic secret.

The nature of the step 130 of receiving depends on the nature of the step 125 of transmitting. In an example shown in FIG. 5A, an instant messaging application is used, the resource address generated being transmitted as a message 505 that has been input using an input field 510. The message 505 can then be viewed and interacted with by the user of the second computing device.

The step 131 of accessing is performed for example, by a computer program run upon the second computing device or a computing device associated with the second computing device, such as a distant server, upon receiving a command emitted by the second computing device.

During this step of accessing 131, the resource address is used to reach the resource, said resource being either distant or local. Preferably, accessing this resource triggers the step of inputting 710 with the objective of, once the cryptographic has been input, triggering the step 135 of registration.

The step 710 of inputting is performed, for example, by a computer program run upon the first computing device or a computing device associated with the first computing device, such as a distant server. The nature of this step 710 of defining depends on the particular implementation use case of the method 700 object of the present invention. Such a step 710 of inputting may use any means of inputting suited for the implemented use case. Such a step 710 of inputting may either be automatic, semiautomatic or manual in nature. An example of such a step 710 of inputting is provided in regard of FIGS. 1 and 2.

The step 135 of registration is performed for example, by a computer program run upon the first computing device or a computing device associated with the first computing device, such as a distant server, upon receiving a command emitted by the first computing device.

The implementation of this step 135 of registration an entry depends on the nature of the distributed ledger technology used. Typically, the confirmation of the addition of the entry relies upon a consensus mechanism, which can be, for example, a proof of work or proof of stake consensus mechanism. Such a step 135 of registration is well known in the field of distributed ledgers.

The distributed ledger technology corresponds to the technology used for the selected cryptographic asset.

Regardless of the underlying distributed ledger technology used, the entry is representative of a transaction in which the public address associated with a first private key is listed as the initiating party (or “sender”) and the public address associated with a second private key is listed as the receiving party (or “recipient”).

An example of such a step 135 of registration is provided in regard of FIGS. 1 and 2. In the example of the DAO described above, the step of 135 registration may correspond to a transaction, initiated by the aspiring member, signing the transaction with the transitory private key transmitted by the administrator.

FIG. 2 represents, in the form of a flowchart, a particular succession of steps of the method 200 object of the present invention. This method 200 configured for the execution of a cryptographic asset transfer transaction on a distributed ledger, comprises:
the step 705 of defining a transaction comprises a step 105 of selecting, upon a computer interface associated to a first computing device of a cryptographic asset associated with a first private address to be transferred to an unknown second private address;
the step 110 of creating a cryptographic secret is configured to generate a transitory private key;
the method further comprises a step 115 of registering an entry in a distributed ledger, by a first computing device, representative of the transfer of a cryptographic asset from a first public address, represented by a first private key, to a transitory public address, associated to the transitory private key;
the step 120 of generating is configured to generate at least one resource address on a computer network comprising information representative of the transitory private key;
the step 125 of transmitting, by the first computing device, at least one resource address on a computer network through a data network;
the step 135 of registration is configured to register a transaction in the distributed ledger, by the second computing device, representative of the transfer of the cryptographic asset from the transitory public address, represented by the transitory private key, to a second address, represented by a second private key associated to the second computing device.

FIG. 2 shows a series of particular embodiments that can be independently implemented, selectively combined or all combined in an advantageous manner.

In particular embodiments, the method 200 comprises, downstream of the step 130 of receiving, a step 205 of creating, by the second computing device, the second private key, said second private key being used during the step 135 of registering a finalized entry.

The step 205 of creating is performed, for example, by a computer program run upon the second computing device or a computing device associated with the second computing device, such as a distant server, upon receiving a command emitted by the second computing device.

Such a step 205 of creating typically involves the creation of an exceptionally large integer value, represented for a user by a series of alphabetic characters organized into distinct words. This integer value, typically randomly generated, acts as a private key in a distributed ledger system. The size of said integer depends on the public-private key protocol used in the distributed ledger technology. For example, on the bitcoin blockchain, the private key is a 256-bit long string.

Such a step 205 of creating corresponds, for example, to the creation of a private key in a wallet type of computer program.

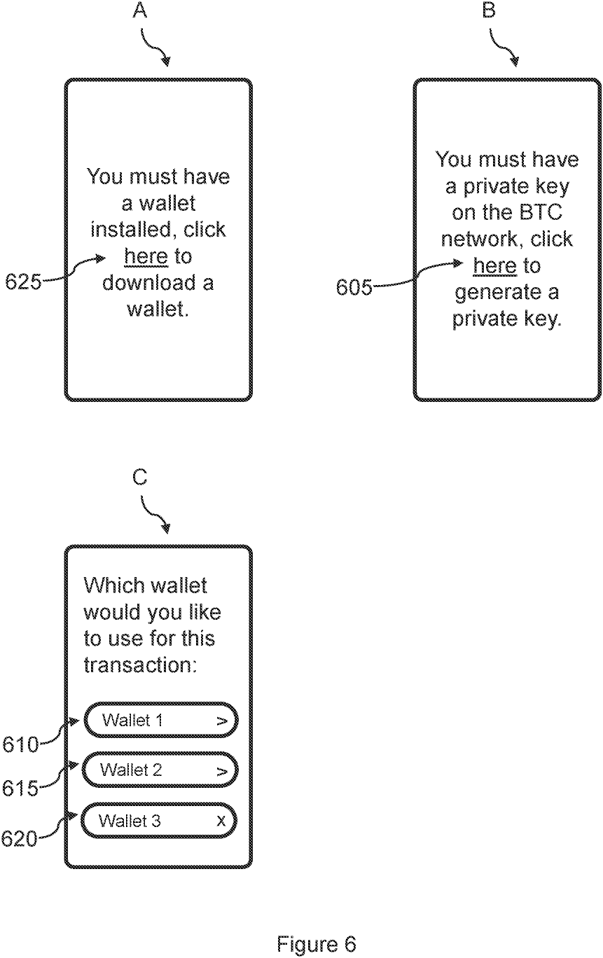

FIG. 6B shows an example of a GUI inviting a user of the second computing device to create a private key with a link 605, which when activated, executes the step 205 of creating.

In particular embodiments, the method 200 comprises, downstream of the step 130 of receiving:
a step 210 of identifying, by the second computing device of at least one private key storage software and
a step 215 of selecting, upon a computer interface associated with the second computing device, an identified private key storage software,
the second private key being associated with the selected private key storage software. The step 210 of identifying is performed, for example, by a computer program run upon the second computing device or a computing device associated with the second computing device, such as a distant server, upon receiving a command emitted by the second computing device.

During such a step 210 of identifying, all wallets compatible with the distributed ledger technology associated with the transferred asset, accessible from the second computing device, are automatically matched with the computer program performing said step 210 of identifying. In other embodiments, separate buttons, on a GUI associated with the step 210 of identifying, are independently associated with different wallets and the click of said button allows for the manual association (or call) of a wallet corresponding to the button of the GUI.

The step 215 of selecting is performed, for example, by a computer program run upon the second computing device or a computing device associated with the second computing device, such as a distant server, upon receiving a command emitted by the second computing device.

During this step 215 of selecting, at least one wallet compatible with the pending transaction is manually or automatically selected. FIG. 6C shows a GUI in which several available wallets, 610, 615 and 620, are identified, with only two wallets, 610 and 615, being compatible with the distributed ledger technology and already having a private key for said distributed ledger technology or allowing the recipient to create one.

In other embodiments, if a wallet is associated with multiple private keys compatible with a distributed ledger technology, the method 200 may comprise a step of selection of at least one private key associated with a wallet that is compatible with the distributed ledger technology upon which the transaction is performed. In particular embodiments, the method 200 comprises a step 220 of association of at least one identifier representative of a type of cryptographic asset and at least one private key storage software, the step 210 of identifying being performed as a function of a type of cryptographic asset associated with the received transitory private key. In such a variant, each wallet may be associated to particular URLs, each URL comprising, for example, a subdomain corresponding to the type of cryptographic asset, such as cosmos.website.com for the Cosmos cryptocurrency. Such a prefix is determined when the cryptographic asset is selected. Each wallet is associated to at least one said URL in a predetermined manner in such a way that, upon opening the URL, the user is presented with only the wallets that are compatible with said URL. The step 220 of association is performed, for example, by the private key storage software.

In particular embodiments, in cases where no compatible wallet is found on the second computing device, the method 200 comprises a step 225 of redirecting to a secondary resource on a computer network as a function of the result of the step 210 of identifying, said secondary resource being configured to download a private key storage software upon the second computing device.

This step 225 of redirecting is performed, for example, by a computer program run upon the second computing device or a computing device associated with the second computing device, such as a distant server, upon receiving a command emitted by the second computing device.

For example, this step 225 of redirecting is performed if no private key storage software accessible to the second computing device is compatible with the distributed ledger technology associated with the transfer. In such an event, the step 225 of redirecting is configured to change the resource address to one that allows for the download of a wallet compatible with the distributed ledger technology of the transfer.

In particular variants, upon the download of said wallet, the user of the second computing device is invited to click on the resource address again to finalize the transaction.

In particular embodiments, the method 200 comprises a step 230 of encoding, by the first computing device, the transitory key to form at least one resource address on a computer network.

This step 230 of encoding is performed, for example, by a computer program run upon the first computing device or a computing device associated with the first computing device, such as a distant server, upon receiving a command emitted by the first computing device. This step 230 of encoding may use any encoding algorithm suited for the particular use case and the level of security required. The encoding key may be transferred alongside the encoded transitory private key, such as by another communication channel or a separate message on the same communication channel for example.

FIG. 6A shows a GUI comprising a link 625 to download a wallet, assuming there is no available wallet that is compatible with the distributed ledger technology that is accessible to the second computing device.

In particular embodiments, the method 200 comprises:
a step 235 of extracting, by the first computing device, a segment of the transitory private key;
a step 240 of sending, by the first computing device, said fragment to the second computing device;
a step 245 of inputting, upon a computer interface associated with the second computing device, the fragment to form a set of at least one complete transitory private key.

The step 135 of registration being performed as a function of the complete transitory private key.

The step 235 of extracting is performed, for example, by a computer program run upon the first computing device or a computing device associated with the first computing device, such as a distant server, upon receiving a command emitted by the first computing device.

For example, during this step 235 of extracting, a set number of characters of the transitory private key is isolated and intended to be transferred via another communication channel and/or in a different message on the same communication channel as the step 125 of transmitting. For example, such a segment is stored on a server that is accessible to the second computing device. In such an example, the user of the second computing device receives a password (said password being representative of the extracted fragment) associated with a resource located on a computer network, the input of said password allowing for the completion of the transitory private key.

The step 240 of sending is performed, for example, by a computer program run upon the first computing device or a computing device associated with the first computing device, such as a distant server, upon receiving a command emitted by the first computing device.

This step 240 of sending may correspond to the direct sending of the extracted segment or to the indirect sending of the extracted segment, which is the sending of a resource address where the segment is accessible, for example.

The step 245 of inputting is performed, for example, by a computer program run upon the second computing device or a computing device associated with the second computing device, such as a distant server, upon receiving a command emitted by the second computing device.

For example, during this step 245 of inputting, input means may be employed so that the segment is input by a user of the second computing device or automatically input from a resource accessible by the second computing device, said resource storing the segment.

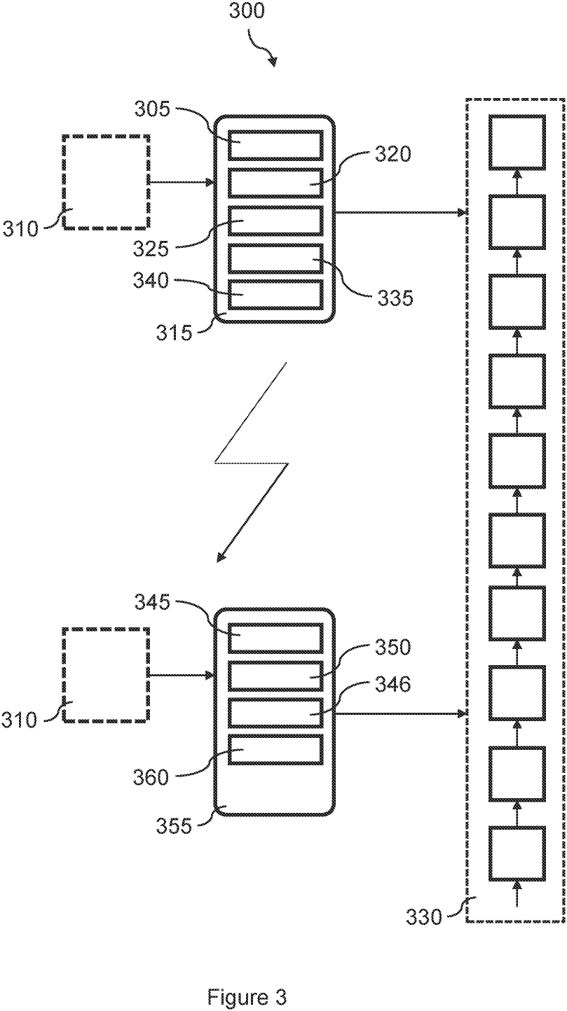

FIG. 3 represents, schematically, a particular embodiment of the system 300 object of the present invention. This system 300 for the execution of a transaction on a distributed ledger comprises:
a first computing device 315 associated with a first public address, comprising a computer interface 310, configured to execute instructions corresponding to the following steps:
a step 705 of defining a transaction with an unknown second public address, said transaction requiring said second public address to be registered on the distributed ledger;
a step 110 of creating a cryptographic secret;
a step 115 of registering a transitory entry in a distributed ledger 330 representative of a preparatory state of the defined transaction, the completion of said transaction being performed as a function of the cryptographic secret;
a step 120 of generating at least one resource address on a computer network representative of the defined transaction;
a step 125 of transmitting at least one resource address on a computer network through a data network and said cryptographic secret;
a second computing device 355 associated with a first public address configured to execute instructions corresponding to the following steps:
a step 130 of receiving at least one transmitted resource address and said cryptographic secret;
a step 131 of accessing a resource corresponding to the received resource address;
a step 710 of inputting the cryptographic secret as a parameter of execution of the defined transaction and
a step 135 of registration of the defined transaction in the distributed ledger as a function of the input cryptographic secret.

Particular implementations of the above means are described with regards to the corresponding methods, 700, 100 and 200, described with regard to FIGS. 1, 2, 4, 5 and 6.

Hereinafter, different variants of the method object of the present invention are presented.

These variants concern the simple and secure transfer by electronic message of cryptographic (or digital) assets stored in a distributed ledger (hereafter “blockchain”). These variants propose a solution to allow a sender with digital assets stored on a blockchain to transfer them in a simple and secure way to a recipient without knowing the address of this recipient on this blockchain, simply by sending an electronic message (for example, by email, SMS, WhatsApp (trademarked), Facebook (trademarked) Messenger (trademarked), Twitter (trademarked), Telegram (trademarked), Signal (trademarked), etc.). This is particularly useful in the case where the recipient does not yet own an electronic wallet and thus democratizes this technology. The assets can be tokens, crypto-currencies, NFTs, or the whole wallet of the sender. This method makes possible new uses, such as the promotional distribution of digital assets to a large number of recipients, which are currently difficult to implement on a large scale.

This novel solution is universal because only the sender’s wallet application and the recipient’s wallet application have access to the digital assets. The assets do not pass through a third party.

A simple version to solve this problem is to allow the wallet application on the sender’s device to:
generate a random private key:
send the digital assets to the public address corresponding to the generated private key and
email this private key to the recipient.

The recipient’s wallet application can then create a wallet by importing the private key communicated in an email for example.

With this approach, the sender can send cryptographic assets without first knowing the recipient’s address. On the other hand, the recipient who receives a private key in the body of an email message cannot do anything with it if he or she does not already have a wallet application installed. And if the recipient already has an address on this blockchain, the recipient must import the transitory address contained in the private key by copying and pasting to access the cryptographic assets and then transfer them to the existing address of the recipient.

In the present solution, the transmission of a private key in the body of a text message, is done through one or more links that have the function of:
redirecting the user to download and install a wallet application if the recipient does not already have one, and
transmitting to the recipient’s wallet application the transitory private key so that it can retrieve the cryptographic assets.

Thus, the recipient can retrieve the cryptographic assets transmitted by the sender by simply clicking on links in a secure and guided manner.

Below, a first variant with a single link is presented.

When the sender wants to send cryptographic assets without knowing the address of the recipient, the sender uses the wallet application installed on the first computing device that:
asks the user what cryptographic asset is to be sent and in what quantity;
generates a new transitory private key on the blockchain;
after confirmation, triggers the sending of the assets to the address associated with this transitory private key;
converts the transitory private key and encodes it into a string such as:
   PVEWr3y6qH7K3aJoK5J2j1nLe9xxd3kKoB42uyjyJYksMUYcHA9oThsYoCZdaAEk5 ZsSJ8V1s8nuxQrRmjE4hanraZGSUbg9ddGm2LLK9PM8jOs4GxB5fnoY9kzv8dduYF nwtS5fDJGgLUt228np8cnGdrc2wmMmWivH4rGVSDPvMFnCTyFkcTM93vrxaoROw Wrdjan8gZ9zPuxNkEVipKpJVou5EdS9kgfG92GRPtc9KcVjq2e8vAVofUMyUHA41pi PjetAYemd91fPF4078HxRFaEv5ozE6m2owvw15pqhUAosha58CDBTLx3P4ammj9 RhCYccbLqvtXMopoCeApfk3odGvv42CjxEycdhJMJis38RMxMpEn4wZo9N5yM2Yso GDHF4ZW3CTnvgBps8Kh42ZiCNKgEJDintZ3V2aKncKzV8ijskz5EcM8wuYZYEsNtL gHWaHJ1nfdnH7toR8YQGERfsDQudbGHSC63QHAEov
inserts this string into an Internet link (URL, for “Unique Resource Locator”), such as :https://solana.cryptoplease.com/?
   data=PVEWr3y6qH7K3aJoK5J2j1nLe9xxd3kKoB42uyjyJYksMUYcHA9oThsYoCZda AEk5ZsSJ8V1s8nuxQrRmjE4hanraZGSUbg9ddGm2LLK9PM8jQs4GxB5fnoY9kzv8d duYFnwtS5fDJGgLUt228np8cnGdrc2wmMmWivH4rGVSDPvMFnCTyFkcTM93vrxao RQwWrdjan8gZ9zPuxNkEVipKpJVou5EdS9kgfG92GRPtc9KcVjq2e8vAVofUMyUHA 41piPjetAYemd91fPF4Q78HxRFaEv5ozE6m2owvw15pqhUAosha58CDBTLx3P4am mj9RhCYccbLqvtXMopoCeApfk3odGvv42CjxEycdhJMJis38RMxMpEn4wZo9N5yM2 YsoGDHF4ZW3CTnvgBps8Kh42ZiCNKgEJDintZ3V2aKncKzV8ijskz5EcM8wuYZYEs NtLgHWaHJ1nfdnH7toR8YQGERfsDQudbGHSC63QHAEov
offers the sender to send an e-mail message containing this link and explaining that the recipient only has to open the link to retrieve the cryptographic assets.

Once the recipient of the message has opened the link, the recipient is guided through the transfer of the cryptographic assets by:
downloading and installing a digital wallet application (optional step): if the proposed digital wallet app is not already installed on the recipient’s device, a message offers to do so;
creating a private address on the blockchain for the recipient (optional step): if the recipient does not yet have an address on the blockchain containing the transferred assets, for example if the recipient has just installed the wallet application, the application suggests the creation of such a private address and
extracting the transitory private key from the link and sending a transaction on the blockchain by signing a message with the transitory private key including the public address of the wallet already set up to transfer the cryptographic asset to the recipient’s wallet.

As understood, in variants, once the receiver clicks on a link, the link including the specific domain name of the wallet application redirects the user to a page that prompts the user to download a wallet application compatible with the recipient’s device and the assets transferred.

Once the application has been installed, if the information contained in the originating link cannot be detected by the wallet application because the user has been redirected to another page before the application is installed and opened, then the user must click a second time on the URL contained in the email in order to return to the cryptographic asset transfer this time.

However, having to click twice on the same link in case the user had not yet installed the application may seem counterintuitive to the user. Thus, a web server can also identify the user before redirecting to the application installation page and later send the link parameters back to the application as soon as the user has installed and opened the wallet.

To avoid having to communicate very long links, the webserver can also shorten the URL and save the link parameters in an external database.

A more secure variant consists in implementing a plurality of URL links. Indeed, communicating the private key in a single URL creates security problems. If the recipient of a message containing the URL does not yet have the application, once the recipient clicks on the URL, a web server will have to redirect the recipient to a page to download the wallet application. If the download server is malicious or simply hacked, it could retrieve the private key before the redirection and retrieve the cryptographic assets.

To prevent the web-server administrator from retrieving the digital assets, the present invention can provide a two-link solution:
In this solution, the application converts the private key and encodes into a string, such as, for example:
   PVEWr3y6qH7K3aJoK5J2j1nLe9xxd3kKoB42uyjyJYksMUYcHA9oThsYoCZdaAEk5 ZsSJ8V1s8nuxQrRmjE4hanraZGSUbg9ddGm2LLK9PM8jQs4GxB5fnoY9kzv8dduYF nwtS5fDJGgLUt228np8cnGdrc2wmMmWivH4rGVSDPvMFnCTyFkcTM93vrxaoRQw Wrdjan8gZ9zPuxNkEVipKpJVou5EdS9kgfG92GRPtc9KcVjq2e8vAVofUMyUHA41 pi PjetAYemd91fPF4Q78HxRFaEv5ozE6m2owvw15pqhUAosha58CDBTLx3P4ammj9 RhCYccbLqvtXMopoCeApfk3odGvv42CjxEycdhJMJis38RMxMpEn4wZo9N5yM2Yso GDHF4ZW3CTnvgBps8Kh42ZiCNKgEJDintZ3V2aKncKzV8ijskz5EcM8wuYZYEsNtL gHWaHJ1nfdnH7toR8YQGERfsDQudbGHSC63QHAEov

Then, the application splits the string in two and includes each part in a URL, such as, for example:
-https://network address1.cryptoplease.com/? data=PVEWr3y6qH7K3aJoK5J2j1nLe9xxd3kKoB42uyjyJYksMUYcHA9oThsYoCZda AEk5ZsSJ8V1s8nuxQrRmjE4hanraZGSUbg9ddGm2LLK9PM8jQs4GxB5fnoY9kzv8d duYFnwtS5fDJGgLUt228np8cnGdrc2wmMmWivH4rGVSDPvMFnCTyFkcTM93vrxao RQwWrdjan8gZ9zPuxNkEVipKpJVou5EdS9kgfG92GRPtc9Kc and
-https://network address2.cryptoplease.com/? data=Vjq2e8vAVofUMyUHA41piPjetAYemd91fPF4Q78HxRFaEv5ozE6m2owvw15pq hUAosha58CDBTLx3P4ammj9RhCYccbLqvtXMopoCeApfk3odGvv42CjxEycdhJMJis 38RMxMpEn4wZo9N5yM2YsoGDHF4ZW3CTnvgBps8Kh42ZiCNKgEJDintZ3V2aKn cKzV8ijskz5EcM8wuYZYEsNtLgHWaHJ1nfdnH7toR8YQGERfsDQudbGHSC63QHA Eov

Then, the application proposes to the sender to send an e-mail message containing these two links to the recipient.

The receiving process is identical to the one-link version described above except that once the wallet is installed, the application asks the user to click on the second link in the email message to finalize the transfer of the digital assets. After clicking on all the links, the application can reconstruct the private key in full and continue the operations. Thus, as it is understood, the present invention is directed in particular to a system that includes:
a blockchain (a decentralized database that can change its state following the receipt of messages signed by a cryptographic key);
the device of a first user;
the device of a second user (the third party) and
a wallet application that can be installed on the users’ device and that can:
sign messages in order to store the messages on the blockchain (transactions);
detect when the user clicks on a certain type of link from another application, open the wallet application and extract the information contained in those types of links;
encode or decode part or all of one or more private keys in one or more normal URLs or short URLs and
detect whether the user has clicked on a URL containing a specific domain name from another application and redirect the user to the wallet application.

Optionally, this system includes:
a host that allows to propose the installation of the wallet application on device if it is not already installed or to open the wallet if it is already installed when the user clicks on one of the links generated by the application;
a host that allows the information encoded in the link to be temporarily stored and transmitted to the application once the electronic wallet application has been installed and then opened and/or
a host that stores a complete URL and redirects to said URL when a corresponding shorter URL is accessed or when a password is entered by the user. In such variants, a link is associated to a particular pin code that is to be entered to access the resource represented by said link.

As it can be understood, several possible methods may be employed by the recipient to reconstitute the transitory private key:
clicking on one or more links successively;
entering one or more secret codes in an application that will retrieve the private key or the different parts of the private key from a server thanks to these codes;
a combination of the above methods, for example by clicking on one link and then entering a code and/or
providing the received message (for example by copy-paste) to an application that will extract the parts of the key inside the links and reconstitute it.

It should be noted that various inventive concepts may be embodied as one or more methods, of which examples have been provided below. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “cryptographic asset” refers to any digital asset, such as cryptocurrency or non-fungible tokens for example.

The terms “computing device” designate any electronic calculation device, whether unitary or distributed, capable of receiving numerical inputs and providing numerical outputs by and to any sort of interface, digital and/or analog. Typically, a computing system designates either a computer executing a software having access to data storage or a client-server architecture wherein the data and/or calculation is performed at the server side while the client side acts as an interface.

The terms “means of inputting” refer to, for example, a keyboard, mouse and/or touchscreen adapted to interact with a computing system in such a way to collect user input. In variants, the means of inputting are logical in nature, such as a network port of a computing system configured to receive an input command transmitted electronically. Such an input means may be associated to a GUI (Graphic User Interface) shown to a user or an API (Application programming interface). In other variants, the means of inputting may be a sensor configured to measure a specified physical parameter relevant for the intended use case.

The terms “resource address” on a network refer to the location, on a computer network, of a particular resource. Typically, on the internet, such a resource address is a URL (for “Unique Resource Locator”), colloquially referred to as a web address or a link. The computer networks targeted in the specification herein are not limited to the internet and can refer to any wired or wireless, direct peer to peer or transport infrastructure-based network. For example, such a network may refer to a Bluetooth network. Such a resource address may also refer to a dynamic link that can be processed locally by the first and/or second computing device, such as by execution instructions of software compatible with said dynamic link.

The term “transaction” refers to the inscription, in a distributed ledger, of an entry signed with the private key of one or more parties, each party being represented with a public address.

The terms “cryptographic secret” designates any digital authentication credential, including passwords, keys, APIs, and tokens for use in applications, services, privileged accounts and other sensitive parts of an information technology ecosystem. Such secrets may include:
User or auto-generated passwords;
API and other application keys/credentials (including within containers);
SSH (for “Secure Shell”) Keys;
Database and other system-to-system passwords;
Private certificates for secure communication, transmitting and receiving of data;
Private encryption keys and/or
RSA (for “Rivest-Shamir-Adleman”) and other one-time password devices.

The terms “private key storage software” refer, in this instance, to what is colloquially referred to as a wallet in distributed ledger technologies. Such computer programs act as means of interacting with a distributed ledger, said interactions (or transactions) requiring a private key to be performed, said private keys being stored in said wallets.

1. Method (700) for the execution of a transaction on a distributed ledger, characterized in that it comprises:
a step (705) of defining a transaction, upon a computer interface associated to a first computing device associated with a first public address, with an unknown second public address, said transaction requiring said second public address to be registered on the distributed ledger;
a step (110) of creating, by the first computing device, a cryptographic secret;
a step (115) of registering a transitory entry in a distributed ledger, by the first computing device, representative of a preparatory state of the defined transaction, the completion of said transaction being performed as a function of the cryptographic secret;
a step (120) of generating, by the first computing device, at least one resource address on a computer network representative of the defined transaction;
a step (125) of transmitting, by the first computing device, at least one resource address on a computer network through a data network and said cryptographic secret;
a step (130) of receiving, by a second computing device, at least one transmitted resource address and said cryptographic secret;
a step (131) of accessing, by the second computing device, a resource corresponding to the received resource address;
a step (710) of inputting, by the second computing device, the cryptographic secret as a parameter of execution of the defined transaction and
a step (135) of registration of the defined transaction in the distributed ledger, by the second computing device, as a function of the input cryptographic secret.

2. Method (100) according to claim 1, configured for the execution of a cryptographic asset transfer transaction on a distributed ledger, in which:
the step (705) of defining a transaction comprises a step (105) of selecting, upon a computer interface associated to a first computing device of a cryptographic asset associated with a first private address to be transferred to an unknown second private address;
the step (110) of creating a cryptographic secret is configured to generate a transitory private key;
the step (115) of registering being configured to register an entry in a distributed ledger, by a first computing device, representative of the transfer of a cryptographic asset from a first public address, represented by a first private key, to a transitory public address, associated to the transitory private key;
the step (120) of generating is configured to generate at least one resource address on a computer network comprising information representative of the transitory private key;
the step (125) of transmitting, by the first computing device, at least one resource address on a computer network through a data network;
the step (135) of registration is configured to register a transaction in the distributed ledger, by the second computing device, representative of the transfer of the cryptographic asset from the transitory public address, represented by the transitory private key, to a second address, represented by a second private key associated to the second computing device.

3. Method (200) according to claim 2, which comprises, downstream of the step (130) of receiving, a step (205) of creating, by the second computing device, the second private key, said second private key being used during the step of registration.

4. Method (200) according to claim 2 which comprises, downstream of the step (130) of receiving:
a step (210) of identifying, by the second computing device, of at least one private key storage software and
a step (215) of selecting, upon a computer interface associated with the second computing device, an identified private key storage software, the second private key being associated with the selected private key storage software.

5. Method (200) according to claim 4, which comprises a step (220) of association of at least one identifier representative of a type of transaction and at least one private key storage software, the step (210) of identifying being performed as a function of a type of transaction associated with the resource address.

6. Method (200) according to claim 4, which comprises a step (225) of redirecting to a secondary resource on a computer network as a function of the result of the step (210) of identifying, said secondary resource being configured to download a private key storage software upon the second computing device.

7. Method (200) according to claim 2, which comprises a step (230) of encoding, by the first computing device, the transitory key to form at least one resource address on a computer network.

8. Method (200) according to claim 2, which comprises:
a step (235) of extracting, by the first computing device, a segment of the transitory private key;
a step (240) of sending, by the first computing device, said fragment to the second computing device;
a step (245) of inputting, upon a computer interface associated with the second computing device, the fragment to form a set of at least one complete transitory private key,
the step (135) of registration being performed as a function of the complete transitory private key.

9. Method (200) according to claim 2, in which at least two complementary resource addresses are generated, each said network address being configured to be opened sequentially by the second computing device.

10. System for the execution of a transaction on a distributed ledger, characterized in that it comprises:
a first computing device (315) associated with a first public address, comprising a computer interface (310), configured to execute instructions corresponding to the following steps:
a step (705) of defining a transaction with an unknown second public address, said transaction requiring said second public address to be registered on the distributed ledger;
a step (110) of creating a cryptographic secret;
a step (115) of registering a transitory entry in a distributed ledger (330) representative of a preparatory state of the defined transaction, the completion of said transaction being performed as a function of the cryptographic secret;
a step (120) of generating at least one resource address on a computer network representative of the defined transaction;
a step (125) of transmitting at least one resource address on a computer network through a data network and said cryptographic secret;
a second computing device (355) associated with a first public address configured to execute instructions corresponding to the following steps:
a step (130) of receiving at least one transmitted resource address and said cryptographic secret;
a step (131) of accessing a resource corresponding to the received resource address;
a step (710) of inputting the cryptographic secret as a parameter of execution of the defined transaction and
a step (135) of registration of the defined transaction in the distributed ledger as a function of the input cryptographic secret.
